(19) United States
(12) Patent Application Publication
(10) Pub. No.: US 2007/0244244 A1
(43) Pub. Date: Oct. 18, 2007

(54) Low oligomer conductive polyamide

(76) Inventors: Franck Bertoux, Wayne, PA (US); Mehdi Emad, Collegeville, PA (US); Benoit Brule, Bernay (FR)

Correspondence Address: Thomas F. Roland, Esq.;Arkema Inc., 2000 Market St., Philadelphia, PA, 19103, US

(21) Appl. No.: 11/403,654

(22) Filed: Apr. 13, 2006

(51) Int. Cl. C08K 3/04

(52) U.S. Cl. 524/495; 524/496

(57) ABSTRACT

The present invention relates to a low oligomer conductive polyamide composition, and articles of manufacture useful in the art of the transport of fluids such as solvents, polar fluids and fuels for applications such as fuel hoses or tubing for internal combustion engines. The material in the hose which is in contact with the fuel must be resistant to the extraction of materials from the hose which precipitate into the fuel or have the potential to clog fuel filters, fuel injectors and the like which have extremely small orifices and, thus, low tolerance for particulates in the fuel. As used herein, the term “low precipitate polyamide” means that the polyamide has been washed or extracted to reduce the level of components such as oligomers (low molecular weight polyamide), solids or semi-solids which would otherwise be released by the polyamide after exposure to the transported fluid and/or precipitate into the fluid.

### FIELD OF THE INVENTION

The present invention relates to a low oligomer conductive polyamide composition. More particularly it relates to compositions of matter classified in the art of chemistry as polyamides, particularly polyamides 11 and 12, articles of manufacture useful in the art of the transport of fluids such as solvents, polar fluids and fuels; for applications such as fuel hoses or tubing for internal combustion engines, particularly engines for use in self-propelled vehicles; as well as processes for said articles of manufacture and of said compositions of matter. The material in the hose which is in contact with the fuel must be resistant to the extraction of materials from the hose which precipitate into the fuel or have the potential to clog fuel filters, fuel injectors and the like which have extremely small orifices and, thus, low tolerance for particulates in the fuel. As used herein, the term “low precipitate polyamide” means that the polyamide has been washed or extracted to reduce the level of components such as oligomers (low molecular weight polyamide), solids or semi-solids which would otherwise be released by the polyamide after exposure to the transported fluid and/or precipitate into the fluid. In some cases, the rubbing of gasoline/inside wall of the tube can produce electrostatic charges, whose accumulation can lead to an electric discharge (spark) that can ignite the gasoline with catastrophic consequences (explosion). Also, it is necessary to limit the surface resistivity of the inside face of the tube to a value that is generally less than 10⁶ ohms. The units of surface resistivity are actually ohms, but are more frequently quoted in ‘ohms per square’ (Ω/sq.) to avoid confusion with usual resistance values.

### BACKGROUND OF THE INVENTION

U.S. Pat. No. 6,467,508 describes in a composition aspect, improved tubing (or hose) for fluid transport comprised of low precipitate polyamide (preferably polyamide 12 or 11), both in the form of monolayer tubing (preferably for conveying fuel) and as multilayer tubing comprised of at least an inner polyamide layer in contact with the fluid and a barrier layer (preferably a fluoropolymer such as a polyvinylidene fluoride, unmodified or modified to improve adhesion using materials such as a polyglutarimide or an acrylate copolymer). Also contemplated as full equivalents by the invention are tubing constructions where the low precipitate polyamide layer in contact with the fuel is conductive to discharge static electricity buildup throughout its entire thickness, has a separate conductive layer of washed polyamide adhered to its inner surface or has a gradient concentration of carbon or other static discharge capable material incorporated when viewed in cross section.

U.S. Pat. No. 6,506,830 describes a composition of antistatic polyamide, comprising at least one polyamide and a sufficient amount of carbon black to make it antistatic, wherein the carbon black is at least a carbon black that is selected from among those that have a specific BET surface area, measured according to ASTM Standard D 3037-89, from 5 to 200 m²/g, in particular from 20 to 100 m²/g, and DBP absorption, measured according to ASTM Standard D 2414-90, from 50 to 300 ml/100 g, in particular from 125 to 250 ml/100 g. (The measurement of the DBP absorption is that of a pore volume that is expressed in ml of di-butyl-phthalate per 100 g of carbon black). In terms of this invention, PA is also defined as the mixtures of polymers that contain at least 50% by weight of polyamides where the matrix phase consists of polyamide. According to this prior art, PA is also defined as the polyamide-based thermoplastic elastomers (TPE) that are block copolymers, also called polyetheramides or polyether block amides, whose rigid sequences consist of polyamide and crystallizable, flexible polyether sequences. The compositions can also contain at least one additive that is selected from among plasticizers and impact modifiers.

U.S. Pat. No. 6,316,537 describes a product made from plastic and composed, at least in part, of a thermoplastic molding composition which comprises polyamide and comprises from 3 to 30% by weight, preferably from 10 to 25% by weight and particularly preferably from 16 to 20% by weight, of a conductivity black, wherein the conductivity black is defined by the following parameters:

a) Dibutyl phthalate (DBP) absorption to ASTM D2414 of from 100 to 300 ml/100 g, preferably from 140 to 270 ml/100 g;

b) a specific surface area, measured via nitrogen absorption to ASTM D3037, of from 30 to 180 m²/g, preferably from 40 to 140 m²/g;

c) an ash content to ASTM D1506 of less than 0.1%. by weight, preferably below 0.06% by weight, particularly preferably below 0.04% by weight, and

d) a grit content of not more than 25 ppm, preferably not more than 15 ppm and particularly preferably not more than 10 ppm, (grit is hard coke-like particles which arise as a result of cracking reactions in the conductivity black preparation process).

If required, the polyamides may be rendered impact-resistant. Examples of suitable modifiers are ethylene-propylene copolymers or ethylene-propylene-diene copolymers, acrylate-nitrile rubber, polypentenylene, polyoctenylene, or copolymers of random or block structure made from alkenylaromatic compounds with aliphatic olefins or dienes. Other impact-modifying rubbers which may be used are core-shell rubbers with an elastomeric core made from (meth)acrylate rubber, from butadiene rubber or from styrene-butadiene rubber with, in each case, a glass transition temperature Tg 21-10° C. The core may have been crosslinked. The shell may be composed of styrene and/or methyl methacrylate and/or of other unsaturated monomers. The proportion of impact-modifying component should be selected in such a way as not to impair the desired properties. The molding compositions may also—apart from the abovementioned impact-resistance components—comprise other blend components, e.g. polyolefins, polyesters or, respectively, polyether block amides (PEBA). They may in addition comprise the usual additives, such as processing aids, mold-release agents, stabilizers, flame retardants, reinforcing agents, e.g. glass fibers or carbon fibers, or mineral fillers, e.g. mica or kaolin, or plasticizers.

The composition described in U.S. Pat. No. 6,647,508 is a low oligomer conductive polyamide but any conductive material is not suitable in compositions to make tubes having high impact strength. The composition described in U.S. Pat. No. 6,506,830 is not a low oligomer conductive polyamide.

It has now been discovered a new composition of low oligomer (also referred as low precipitate) conductive polyamide which is: conductive, flexible, ductile, and easy to process. This new composition fulfills the technical standards SAE J 1645 and 2260. In addition, according to the Ford method, extractable tests do not reveal any solid contamination for this new formulation.

### SUMMARY OF THE INVENTION

This invention is a composition of antistatic polyamide, comprising at least one polyamide and a sufficient amount of antistatic agent to make it antistatic, wherein:

a) the antistatic agent is selected from the carbon black, carbon nanotubes and conductive fibers.

b) the polyamide is defined as the mixtures of polymers where the matrix phase consists of polyamide,

c) the polyamide is a low precipitate polyamide.

The measurement of the DBP absorption is that of a pore volume that is expressed in ml of di-butyl-phthalate per 100 g of carbon black.

“low precipitate polyamide” means a polyamide (or mixtures of polymers where the matrix phase consists of polyamide) which passes the Ford test.

Ford test is an extraction phase followed by a filtration phase (0.45 μm pore size filter) and is as follows:

Fill up the monolayer polyamide tube with gasoline CE10,

Exposure time and temperature: 48 h at 60° C.,

Remove the fuel and store at 0° C. during 24 h,

Filtration phase.

The polyamide passes the Ford test if no solids are recovered in the filtration and the fuel in contact with the low oligomer conductive polyamide is always clear.

The present invention also relates to structures having a layer made of the above composition, that is to say the structure may be either a monolayer, and therefore consist of one layer of the above composition, or a multi-layer, and therefore include a inner layer made of the above composition, said inner layer is the layer in contact with the fluid to be stored or transferred. This structure is useful for making devices for storing or transferring fluids, in particular in cars and heavy vehicles. The fluids may for example be petrol, solvents or polar fluids. The invention also relates to these devices, which may be tanks, pipes, hoses and containers. These structures may include other layers made of other materials, and may be manufactured by standard techniques, such as extrusion, coextrusion, coextrusion-blow moulding, coating and extrusion-coating.

### DETAILED DESCRIPTION OF THE INVENTION

As regards the polyamide, it is prepared from starting materials of essentially an amino acid, a lactam or a diamine, and a dicarboxylic acid. Mention may be made of one or more salts or mixtures of diamines such as hexamethylenediamine, dodecamethylenediamine, meta-xylylenediamine, bis(p-aminocyclohexyl)methane and trimethylhexamethylenediamine with diacids such as isophthalic, terephthalic, adipic, azelaic, suberic, sebacic and dodecanedicarboxylic acid. Examples of alpha,omega-amino carboxylic acids that may be mentioned include aminoundecanoic acid and aminododecanoic acid. Examples of dicarboxylic acids that may be mentioned include adipic acid, sebacic acid, isophthalic acid, butanedioic acid, 1,4-cyclohexanedicarboxylic acid, terephthalic acid, the sodium or lithium salt of sulphoisophthalic acid, dimerized fatty acids (these dimerized fatty acids having a dimer content of at least 98% and preferably being hydrogenated) and dodecanedioic acid, HOOC—(CH₂)₁₀—COOH. The diamine can be an aliphatic diamine having 6 to 12 carbon atoms; it may be of aryl and/or saturated cyclic type. Examples that may be mentioned include hexamethylenediamine, piperazine, tetramethylenediamine, octamethylenediamine, deca-methylenediamine, dodecamethylenediamine, 1,5-diaminohexane, 2,2,4-trimethyl-1,6-diaminohexane, diamine polyols, isophoronediamine (IPD), methylpentamethylenediamine (MPDM), bis(aminocyclohexyl)methane (BACM) and bis(3-methyl-4-aminocyclohexyl)methane (BMACM).

It could be also a copolyamide to be prepared from at least an amino acid or a lactam, a diamine and a dicarboxylic acid.

Mention may be made of PA-11, PA-12, PA 6/6,6, PA 6/12 and PA 6.

Mention may also be made of those of formula X, Y/Z or 6, Y2/Z in which:

X denotes the residues of an aliphatic diamine having from 6 to 10 carbon atoms;

Y denotes the residues of an aliphatic dicarboxylic acid having from 10 to 14 carbon atoms;

Y2 denotes the residues of an aliphatic dicarboxylic acid having from 15 to 20 carbon atoms; and

Z denotes at least one unit chosen from the residues of a lactam, the residues of an alpha, omega-aminocarboxylic acid, the unit X1, Y1 in which X1 denotes the residues of an aliphatic diamine and Y1 denotes the residues of an aliphatic dicarboxylic acid,

the weight ratios Z/(X+Y+Z) and Z/(6+Y2+Z) being between 0 and 15%.

Mention may be made by way of example of PA-6, 10 (hexamethylenediamine and sebacic acid units), PA-6, 12 (hexamethylenediamine and dodecanedioic acid units), PA-6, 14 (hexamethylenediamine and C14 diacide), PA-6, 18 (hexamethylenediamine and C18 diacide) and PA-10, 10 (1,10-decane diamine and sebacic acid units).

Mention may also be made of polyamides of formula X/Y, Ar in which:
Y denotes the residues of an aliphatic diamine having from 8 to 20 carbon atoms;
Ar denotes the residues of an aromatic dicarboxycylic acid;
X denotes either the residues of aminoundecanoic acid NH₂—(CH₂)₁₀—COOH, of lactam 12 or of the corresponding amino acid, or the unit Y,x remains from the condensation of the diamine with an aliphatic diacid (x) having between 8 and 20 carbon atoms or else the unit Y, I remains from the condensation of the diamine with isophthalic acid.
   X/Y, Ar denotes, for example:

11/10, T, which results from the condensation of aminoundecanoic acid, 1,10-decanediamine and terephthalic acid;

12/12, T, which results from the condensation of lactam 12, 1,12-dodecanediamine and terephthalic acid;

10,10/10, T, which results from the condensation of sebacic acid, 1,10-decanediamine and terephthalic acid; and

10, I/10, T, which results from the condensation of isophthalic acid, 1,10-decanediamine and terephthalic acid.

The inherent viscosity of the polyamide of the outer layer (1) may be between 1 and 2 and advantageously between 1.2 and 1.8. The inherent viscosity is measured at 20° C. for a 0.5% concentration in metacresol.

By way of example of mixtures, it is possible to cite the mixtures of aliphatic polyamides and semi-aromatic and/or amorphous polyamides, such as those described in EP 550308 and EP 628602.

The polyamide is defined as the mixtures of polymers where the matrix phase consists of polyamide, therefore it could be polyamides alone, blends of polyamides or mixtures of polymers where the matrix phase consists of polyamide. Advantageously there is a polyamide matrix and a dispersed polyolefin phase. More advantageously there is (not including the anti-static agent) 50 to 100% by weight of polyamide and respectively 50 to 0% of the polyolefin. The polyolefin term means homopolymers as well as copolymers, thermoplastics as well as elastomers. They are for instance copolymers of ethylene and an α-olefin. These polyolefins can be any LLDPE, PE, EPR and EPDM. They can be completely or partly functionalized. The dispersed phase can a blend of one or several non-functional polyolefins and one or several functional polyolefins.

According to a preferred embodiment, the PA—polyolefin blends with a PA matrix comprise, the total adding to 100%:
40 to 75 weight % (advantageously 45 to 70%) of PA,
1 to 30 weight % (advantageously 5 to 25%) of at least an impact modifier P1, at least one of the P1 being completely or partly functionalized,
15 to 30 weight % (advantageously 17 to 24%) of the antistatic agent.
0 to 10 weight % (advantageously 2-9%) of a plasticizer.

Advantageously the impact modifier is chosen from elastomers and very low density polyethylenes. As regards the impact modifiers and firstly the elastomers, mention can be made of blocks polymers such as SBS, SIS, SEBS and the ethylene/propylene elastomers (EPR) or ethylene/propylene/diene (EPDM) elastomers. As for the very low density polyethylenes, they can be for instance metallocenes with density for instance between 0.860 and 0.900. Advantageously an ethylene/propylene elastomers (EPR) or an ethylene/propylene/diene (EPDM) is used. The functionalization can be carried out by grafting or copolymerization with an unsaturated carboxylic acid. It would not be outside the scope of the invention to use a functional derivative of this acid. Examples of unsaturated carboxylic acids are those having 2 to 20 carbon atoms, such as acrylic, methacrylic, maleic, fumaric and itaconic acids. The functional derivatives of these acids comprise, for example, anhydrides, ester derivatives, amide derivatives, imide derivatives and metal salts (such as alkali metal salts) of unsaturated carboxylic acids. Unsaturated dicarboxylic acids having 4 to 10 carbon atoms and their functional derivatives, particularly their anhydrides, are particularly preferred grafting monomers. Advantageously maleic anhydride is used.

As regards the antistatic agents, mention may be made, by way of example, of carbon black, carbon fibres and carbon nanotubes. In one embodiment, the antistatic agent is a carbon black chosen from those having a BET specific surface area, measured according to the ASTM D 3037-89 standard, of 5 to 200 m²/g and preferably from 20 to 100 m²/g and a DBP absorption, measured according to the ASTM D 2414-90 standard, of 50 to 300 ml/100 g, and preferably from of 50 to 300 ml/100 g is used. The proportion of black by weight is advantageously from 15 to 30% per 85 to 70% of the other constituents, respectively, and preferably from 17 to 24% per 83 to 76% of the other constituents, respectively.

Furthermore, the polyamide-based antistatic compositions of the invention preferably contain 16 to 30% by mass of these “less structured” conductive or semi-conductive carbon black(s) and more particularly 17 to 24% by mass, relative to the total composition.

The polyamide-based antistatic compositions of the prior art, using “more structured” extra-conductive carbon blacks, generally contain 4 to 14% by mass, and more particularly 6 to 10% by mass to obtain the same antistatism level.

As regards the low precipitate polyamide, methanol has been found to be especially useful for preparing the low precipitate polyamide (preferably polyamide 11 or 12). The actual techniques of washing the polyamide with methanol are not particularly critical, as the polymer simply needs to be washed using any convenient technique and equipment such that the wash shows a substantial reduction in extractable components. If desired, solvents with similar solubility capability for polyamide oligomers may be substituted for methanol. The washing can be performed at any stage of preparation of the hose/tubing. That is, the fresh resin as received from the synthesis may be washed, the resin compounded with suitable plasticizers, such as N-n-butyl benzene sulfonamide, and any other desired additives may be washed, or after preparation of a complete multilayer hose, the interior polyamide resin layer can be washed.

Oligomers content in PA have been analyzed and quantified through High Pressure Liquid Chromatography (HPLC), measurement of extractable is made in reflux alcohol (kumagawa apparatus). It has been noticed that a polyamide having an oligomer content of 0.3% or lower passes the Ford test.

The compositions according to the invention can also contain at least one additive that is selected from among:
phosphoric acid, phosphorus acid or hydrophosphorus acid or their esters, or sodium salts or potassium salts or combinations of these products;
dyes;
pigments, other than carbon black;
brighteners;
antioxidants;
UV stabilizers.

The compositions according to the invention can be obtained in a known way by any technique of mixing components in the molten state such as, for example, the extrusion or compounding on a single- or double-screw extruder, on a co-mixing machine or by any other continuous or intermittent technique, such as, for example, with an internal mixer.

In particular, on a co-mixing machine-type extruder, it is possible to introduce the carbon black(s) in a molten zone, the granules of the polyamide(s), if necessary modified by at least one additive as defined above, whereby a portion is introduced into the feed hopper and a portion is introduced with the carbon black(s).

This invention also relates to the processes for transformation of said compositions, as well as the articles that are obtained. The articles that are obtained can be tubes, films, pipes, plates, fibers, etc. These materials or articles can be single-layer or multi-layer. In the case of multi-layer materials or articles, the layer that is most exposed to the accumulation of the electrostatic charges will be based on a composition according to the invention. The invention makes it possible in particular to use an antistatic and shock-resistant single- or multilayer tube for the transport and/or storage of hydrocarbons and in particular gasoline. Among all of the conventional transformation methods used in the thermoplastics industry that are suitable for the production of articles, very particularly the extrusion and co-extrusion techniques will be cited.

Some exemplary embodiments are given below. One in the art can imagine many other embodiments based on these examples and the description given above:

Single-layer quick connector made from a molding composition according to the invention which in addition comprises 3 to 10% of glass fibers.

Monolayer Pipe

Pipe comprising successively
a) an outer layer made from a polyamide molding composition,
b) optionally a tie layer,
c) a barrier layer chosen among PVDF, PVDF-functionnalized PMMA blends,

EVOH,
d) optionally a tie layer,
e) an antistatic inner layer according to the present invention.

Pipe comprising successively
a) an outer layer made from a polyamide molding composition,
b) optionally a tie layer,
c) an EVOH barrier layer,
d) a PA 6 layer,
e) optionally a tie layer,
f) an antistatic inner layer according to the present invention.

Pipe comprising successively:
a) a polyamide molding composition, if desired impact-modified,
b) optionally a tie layer,
1 an antistatic inner layer according to the present invention.

1. A low oligomer composition of antistatic polyamide, comprising:
a) at least one polyamide, wherein said polyamide is a mixture of polymers where the matrix phase consists of a polyamide and wherein said polyamide is a low precipitate polyamide; and
b) an effective amount of an antistatic agent to make said composition antistatic.

2. The low oligomer composition of claim 1, wherein said polyamide is a polyamide, copolyamide, or a mixture of polyamides.

3. The low oligomer composition of claim 1, wherein said antistatic agent is selected from the group consisting of carbon black, carbon fibres, and carbon nanotubes.

4. The low oligomer composition of claim 3, wherein the antistatic agent is a carbon black that is selected from among those that have a specific BET surface area, measured according to ASTM Standard D 3037-89, of from 5 to 200 m²/g, and DBP absorption, measured according to ASTM Standard D 2414-90, of from 50 to 300 ml/100 g.

5. The low oligomer composition of claim 4, wherein the antistatic agent is a carbon black that is selected from among those that have a specific BET surface area, measured according to ASTM Standard D 3037-89, of from 20 to 100 m²/g, and DBP absorption, measured according to ASTM Standard D 2414-90, of from 125 to 250 ml/100 g.

6. The low oligomer composition of claim 1, wherein said polyamide comprises a polyamide matrix and a dispersed polyolefin phase.

7. The low oligomer composition of claim 1, comprising:
a) 40 to 75 percent by weight of said polyamide;
b) 1 to 30 weight percent of at least one impact modifier;
c) 15 to 30 weight percent of said antistatic agent;
d) 0 to 10 weight percent of a plasticizer;
wherein said percentages add up to 100 percent.

8. The low oligomer composition of claim 7, comprising:
a) 45 to 70 percent by weight of said polyamide;
b) 5 to 25 weight percent of at least one impact modifier;
c) 17 to 24 weight percent of said antistatic agent;
d) 2 to 9 weight percent of a plasticizer;
wherein said percentages add up to 100 percent.

9. The low oligomer composition of claim 7, wherein said impact modifier is completely or partially functionalised.

10. The low oligomer composition of claim 1, wherein said composition has an oligomer content of less than 0.3% based on extraction in reflux alcohol.

11. The low oligomer composition of claim 1, further comprising at least one additive selected from the group consisting of phosphoric acid, phosphorus acid, and hydrophosphorus acid; the esters of phosphoric acid, phosphorus acid, and hydrophosphorus acid; the sodium and/or potassium salts of phosphoric acid, phosphorus acid, and hydrophosphorus acid; dyes; pigments, other than carbon black; brighteners; antioxidants; and UV stabilizers.

12. An article or structure comprising at least one layer comprising the low oligomer composition of claim 1.

13. The article or structure of claim 12 comprising a tube, film, pipe, plate, or fiber.

14. The article or structure of claim 12, wherein said article or structure is of a mono-layer construction.

15. The article or structure of claim 12, wherein said article or structure is of a multi-layer construction.

16. The article or structure of claim 12, wherein said article or structure further comprises one or more tie layers.
